(19) United States
(12) Patent Application Publication
(10) Pub. No.: US 2003/0177010 A1
(43) Pub. Date: Sep. 18, 2003

(54) Voice enabled personalized documents

(76) Inventor: John Locke, Ventura, CA (US)

Correspondence Address: Mitchell, Silberberg & Knupp, LLP, Trident Center, 11377 West Olympic Boulevard, Los Angeles, CA, 90064-1683, US

(21) Appl. No.: 10/384,625

(22) Filed: Mar. 11, 2003

Related U.S. Application Data
(60) Provisional application No. 60/363,293, filed on Mar. 11, 2002.

(51) Int. Cl. G10L 13/08

(52) U.S. Cl. 704/260

(57) ABSTRACT

Voice Enabled Personalized Documents are documents that are highly personalized to an audience of one. That is, we are creating one to one communication documents that are voice enabled. The overall concept is to take personalized documents that contain unique information to an individual and voice-enable them. By doing this, we open up several new forms of delivery of personalized documents to the audience of our customers. The product that we are planning to offer utilizes technology to produce and assemble personalized messages for each person in a group that is the target audience. The personalized documents that we produce will have audio that includes personal information, some examples of this are the persons name, membership information, information regarding activity with a group etc. With these messages we will provide highly personalized information to users using high quality speech that will be acceptable to the end audience. Coming at the market from the personalized documents perspective provides us the opportunity to look at the market from a new perspective. Elixir has been providing personalized documents to users in the form of printed, email and web sites for a number of years. We will now be providing the market with speech-enabled documents as well.

This application claims the benefit of provisional application 60/363,293, filed Mar. 11, 2002.

### BACKGROUND OF THE INVENTION

There are several products on the market today that are in the process of providing information to users using speech technology. For this discussion the existing products can be separated into two main categories, described in the following discussion.

One category of products is using Text to Speech (TTS) technology on any electronically formatted text. This technology is being used to provide information of all sorts to users in an audio format. The information is normally provided over the phone to the users. The main drawback with this technology is the poor quality of speech is often unacceptable to most users. This speech can sound robotic and does not have the proper inflection and intonation, thus it does not sound comfortable to the general public.

Another category of products is using recorded speech fragments to provide high quality speech to users. This technology provides much better quality of speech but is limited to providing a limited set of information to users due to the need for prerecorded speech. These prerecorded fragments are then used to build the messages that are spoken to the users. Currently this technology is being used to provide generic information to users such as news, weather, stock information, etc. This technology is not generally being used today to provide personalized information to users.

As described above the existing technology provides the ability to deliver messages to users. If a business desires to send non personalized messages to users, existing technology provides this capability by allowing the business to record messages and assemble them into the desired message. These messages are then delivered using what ever means is appropriate at that time. If, however, the business desires to provide personalized speech messages to each user, this is currently done using Text to Speech technology. This works well in an environment having a captured audience where the quality of these messages is of little importance. An example of this is a system delivering messages to employees of a business. This technology is not adequate when the messages are being delivered to the public at large.

### SUMMARY OF THE INVENTION

Voice enabling documents provides another means of delivering documents to users. The word ‘document’ used throughout this patent is defined as a set of information or content that has been personalized to a particular audience, including an individual, and can be delivered to the particular audience regardless of the information [symbol] s media type. That means delivering documents to end-users via whatever media type is most appropriate for the end-user at that moment in time.

Voice Enabled Personalized Documents are documents that are highly personalized to an audience. These are one to one communication documents that are voice enabled. The overall concept is to take personalized documents containing information unique to an individual and voice-enabling them. By doing this, several new forms of document delivery are provided to the user community. This also provides information to people that have a visual impairment, which prevents them from receiving these documents without assistance.

There are approximately 850,000 people who are blind in the United States today. This population is increasing by approximately 8% per year. By voice enabling documents such as bills, loyalty program documents, financial statements etc., these people can have an added level of independence that they do not enjoy today. Braille is available for non-personalized documents such as books and periodicals, but nobody is providing personalized documents, enabling these individuals another means of independent living.

Voice enabling individual documents gives the ability to communicate important information to people as they travel -and go about their day. They have the ability to call in to a portal to retrieve real time oriented information unique to them. The system can initiate a call to the user to provide personalized information and send e-mails with personalized voice attachments. The system has a web service users can interact with to provide voice-enabled documents.

The system combines Text to Speech and recorded speech fragment technologies to deliver high quality messages personalized to each user. The product provides the ability to record message fragments and store them in a way making them easy to retrieve when needed. The Text to Speech capability converts the personalized information for each user from data to speech. The system then combines the prerecorded message fragments along with the personalized Text to Speech for each user into unique messages for the user. The personalized data from each user is retrieved from a data base at the time the messages are assembled. By combining these technologies the system delivers high quality speech messages personalized for each user, where the users are generally the public.

The system has three main subsystems; the Composer, the Management Console and the Production and Delivery. The Composer designs the customized messages. The Management Console defines the production of the messages and extracts the personalized data from the user's database. The Production and Delivery system produces the individualized messages and delivers them to the users under the control of the Management Console.

### BRIEF DESCRIPTION OF THE DRAWINGS

Referring now to the drawings wherein the product is further described, the figures are:

FIG. 1 depicts the subsystems and the components of the Systems application;

FIG. 2 shows the cycle to create a message to be sent to a set of users;

FIG. 3 shows the interaction of the Production and Delivery system with external applications over an external software interface; and

FIG. 4 shows the high level architecture of the system.

### DETAILED DESCRIPTION OF THE INVENTION

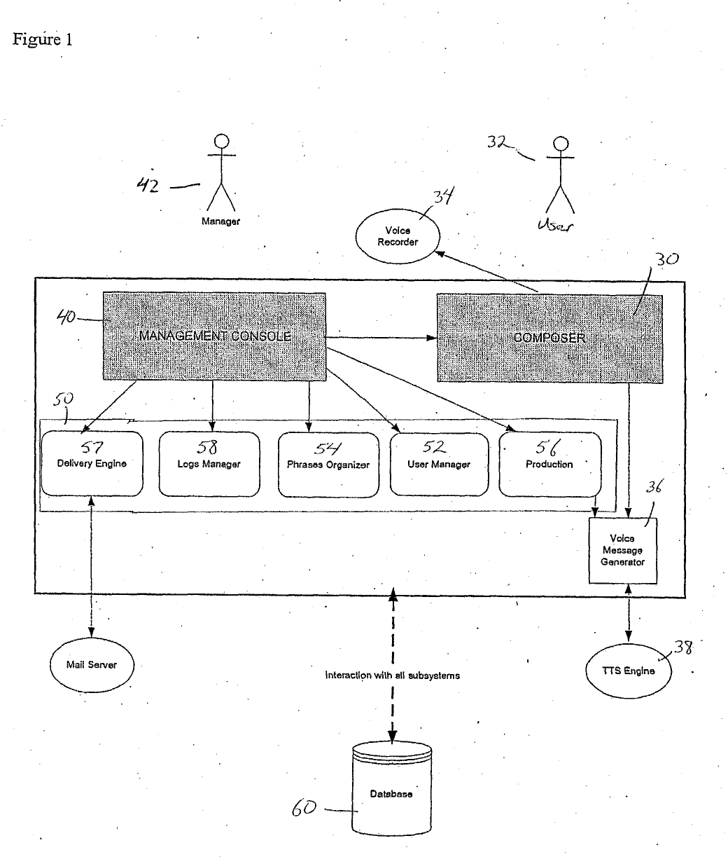

The system is comprised of three main subsystems, as depicted in FIG. 1. The system contains two user interface domains, the composer domain 30 and the management console 40. The composer domain allows a user 32 to create a set of messages with a voice recorder 34. The composer records fragments, assembles fragments and stores the fragments created by the composer. The user records new fragments, utilizes previously recorded fragments, and selects data elements that will be imported from the database 60. A voice message generator 36 generates a test message for the user's approval along with a text-to-speech (TTS) engine 38 using the first record in the database. The TTs engine transforms the database information into speech. The result is a voice message template.

The second user interface is the management console 40. Manager 42 uses the management console to specify to which database the system will be attached. The database includes a list of recipients and the personalized data for each recipient. In most instances, the user will provide a database for the recipients of the message generated by the user. The system can be used with a plurality of databases and it is the manager's responsibility to specify the databases being accessed by the system.

The third subsystem is the production and delivery system 50 shown in its various components in FIG. 1. The subsystems include the user manager 52 allowing a subset of the chosen database to be accessed. This will often occur whenever the user does not want all recipients listed in the database to receive the composed message. The phrase organizer 54 includes recorded phrases, usually recorded by a professional voice talent. The recorded phrases include phrases in various languages, regional accents, and male and female voices. With the variety of phrases stored by the phrase organizer, a message in any language, regional accent and male or female voice may be chosen for each recipient.

The production component 56 produces messages for each recipient. The production component uses the message template recorded by the user in the composer domain and retrieves data for each user stored in the database 60. This information is provided to the voice generator which uses the TTS engine to convert the database information to speech. This is combined with phrases from the Phrase Organizer component in the appropriate accent, gender and language for the recipient. The completed message is sent back to the Production component where it is combined with information regarding the recipient such as email addresses. The package is sent to the delivery component 57 for delivery to the recipient. This process is repeated for every recipient.

The delivery component 57 includes information for each recipient regarding the software used by the user. The types of software which may be used include Outlook®, Netscape® or Eudora®. The message is delivered to the recipient via whichever means is appropriate for the user at the time. All information regarding the message, including the recipient, time and message is recorded in the log's manager 58. The log manager 58 documents the sending of each message and is useful for billing purposes.

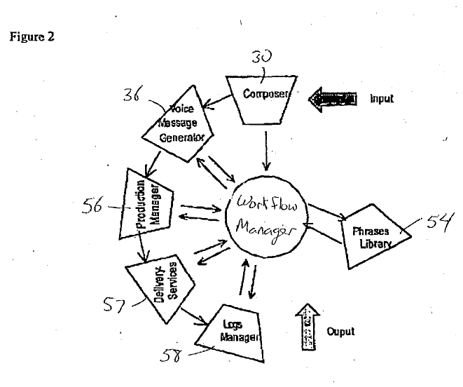

A linear model of the message creation and delivery is shown in FIG. 2. The composer domain receives input from the user and TTS engine to enable the voice message generator 36 to create a template. The template is passed to the production manager 56 at which time the template created by the user is converted into an appropriate regional accent, male or female voice, and information, such as account numbers, names, addresses retrieved from a database and sent through a TTS engine are combined to produce the final message for each user. The final message is sent to delivery services 57 for delivery to each recipient in an appropriate manner. The sending of a message is documented in a log's manager 58. The entire process is controlled by a Workflow manager 65 overseeing and facilitating the transfer of data between the various systems and components.

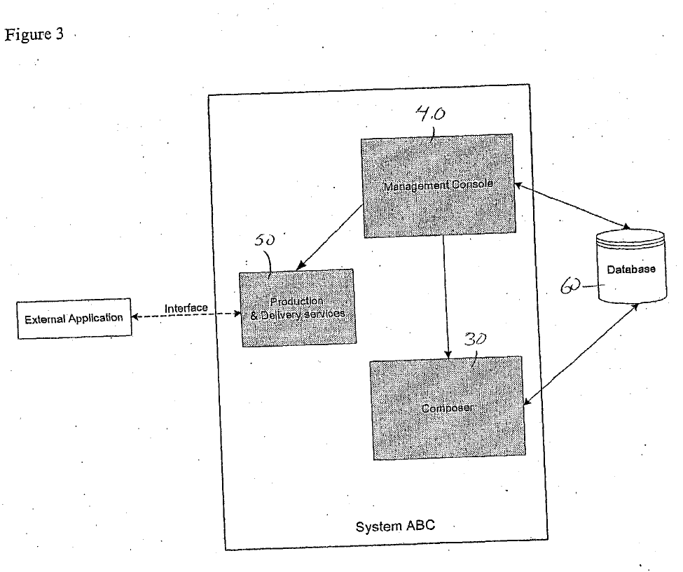

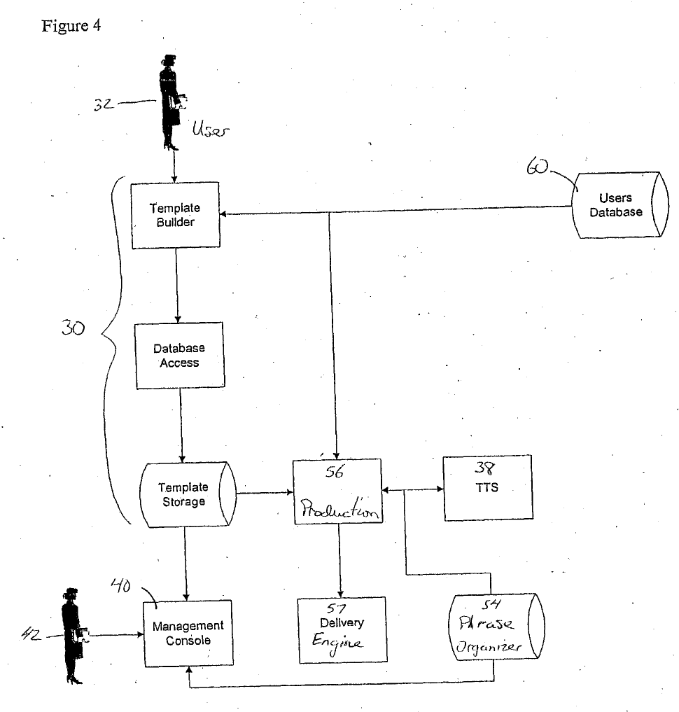

FIG. 3 shows the three main subsystems and the external connections needed for the system to properly perform. The system accesses a database containing the user's personalized information used within the message and a connection to an external application for the delivery of these messages. FIG. 4 depicts the unit architecture of the system. The user 32 uses a template builder and database access to build and store a template within the composer domain 30. The template builder uses the user database 60 to fill in personalized content for each recipient. The manager 42 uses the management console 40 to select recipients of the message by designating a database. During production, the merger builds messages for each user, one at a time, by using the template, phrase organizer and user database to create the personalized message for each recipient. Once completed, the delivery engine 57 sends the message to the recipient in the appropriate manner regarding the external application, such as Outlook®, Netscape® or Eudora®, appropriate for the user.

The system allows personalized messages for each recipient with the personalized information supplied by a database.

While the invention has been described with reference to a preferred embodiment, variations and modifications would be apparent to one of ordinary skill in the art. The invention encompasses such variations and modifications without departing from the scope and spirit of the invention.

I claim:

1. A method for producing personalized voice messages comprising:
recording a message template,
recording sentence fragments,
using a text-to-speech engine to convert personal information for each message recipient into speech,
merging said sentence fragments and said personal information recording to produce a personalized message, and
sending said personalized message to each recipient.

2. The method of claim 1, further comprising recording said sentence fragments in a variety of regional accents, and merging an appropriate regional accent and personal information for each recipient.

3. The method of claim 1, further comprising sending said personalized message to a delivery engine, said delivery engine choosing the appropriate delivery media for each recipient.

4. The method of claim 3, further comprising recording the time and content of every message in a log manager.

5. A personalized voice message system comprising
a water interface allowing a user to create a message template;
a manager interface allowing a manager to choose a database accessed by the system;
a production and delivery subsystem for creating a personalized message for each of a plurality of recipients from said message template and delivering said personalized message in a format appropriate for each recipient.

6. The system of claim 5, wherein
said production and delivery subsystem includes personal information from said database for each recipient.

7. The system of claim 5, wherein
said production and delivery subsystem creates a personalized message in a language, accent and gender appropriate for each recipient.

8. The system of claim 5, further comprising
a text-to-speech engine for converting personal information for each recipient in said database into speech.
